(19) United States
(12) Patent Application Publication
(10) Pub. No.: US 2026/0011067 A1
(43) Pub. Date: Jan. 8, 2026

(54) METHOD AND APPARATUS FOR RENDERING DRM CONTENT IN XR DEVICE, DEVICE, AND MEDIUM

(71) Applicant: Beijing Zitiao Network Technology Co., Ltd., Beijing (CN)

(72) Inventor: Xiao MA, Beijing (CN)

(21) Appl. No.: 19/257,954

(22) Filed: Jul. 2, 2025

(30) Foreign Application Priority Data
Jul. 5, 2024 (CN) 202410904183.3

(51) Int. Cl. G06T 15/00; G06F 21/10; G06T 19/00

(52) U.S. Cl. CPC G06T 15/005; G06F 21/109; G06T 19/00

(57) ABSTRACT

Embodiments of the present disclosure provide a method and an apparatus for rendering a DRM content in an XR device, a device, and a medium. The method includes: rendering, by the render server, the DRM content onto a protected Surface when the DRM content is displayed by a target XR application; reading, by the render server, render data of the DRM content from the protected Surface through a protected first context, performing fusion rendering on the render data of the DRM content and a current scene in a same space to obtain first render data and storing the first render data into a protected first buffer; and reading, by the compositor, the first render data from the protected first buffer through a protected second context, performing a compositing process on the first render data to obtain a first to-be-displayed image and displaying the first to-be-displayed image on screen.

### CROSS-REFERENCE TO RELATED APPLICATIONS

The present application claims the priority to and benefits of the Chinese Patent Application, No. 202410904183.3, filed on Jul. 5, 2024. The aforementioned patent application is hereby incorporated by reference in its entireties.

### TECHNICAL FIELD

Embodiments of the present disclosure relate to the technical field of virtual reality, and in particular to a method and an apparatus for rendering a DRM content in an XR device, a device, and a medium.

### BACKGROUND

Extended reality (XR) refers to the combination of reality and virtuality through a computer to create a human-computer interactive virtual environment. XR is also a collective term for a variety of technologies such as virtual reality (VR), augmented reality (AR) and mixed reality (MR). By integrating visual interaction technologies of virtual reality, augmented reality and mixed reality, it brings a “sense of immersion” of seamless transition between a virtual world and a real world to the user.

In an XR device, a user may face the situation of playing a digital rights management (DRM) video. A DRM content is a video content encrypted and managed by a DRM technology, and the copying and use of the DRM content are limited. Under normal circumstances, the DRM content can be played normally, but it is not possible to take screenshots or record protected DRM content through other means. In related art, the playback effect of playing the DRM content on the XR device is not good.

### SUMMARY

Embodiments of the present disclosure provide a method and an apparatus for rendering a DRM content in an XR device, a device, and a medium, in which, both the DRM content and a current scene are processed in a protected demand and buffer, a display panel of the DRM content and content of the current scene can be subjected to fusion rendering in the same space, thus, the DRM content can be played by the XR device in a better effect.

In a first aspect, embodiments of the present disclosure provide a method for rendering digital rights management (DRM) content in an extended reality (XR) device, wherein the method is applied to the XR device having a render server and a compositor running thereon, and the method includes:
rendering, by the render server, the DRM content onto a protected Surface when the DRM content is displayed by a target XR application;
reading, by the render server, render data of the DRM content from the protected Surface through a protected first context, performing fusion rendering on the render data of the DRM content and a current scene in a same space to obtain first render data and storing the first render data into a protected first buffer; and
reading, by the compositor, the first render data from the protected first buffer through a protected second context, performing a compositing process on the first render data to obtain a first to-be-displayed image and displaying the first to-be-displayed image on screen.

In some implementations, before performing, by the render server, fusion rendering on render data of the DRM content and the current scene in a same space through the protected first context, the method further includes: detecting a playback status of the DRM content; performing, by the render server, fusion rendering on the render data of the DRM content and the current scene in the same space through the protected first context when the playback status of the DRM content is normal playback.

In some implementations, the method further includes: performing, by the render server, fusion rendering on the render data of the DRM content and the current scene in the same space to obtain second render data through a non-protected first context and storing the second render data into a non-protected second buffer when the playback status of the DRM content is abnormal playback; and reading, by the compositor, the second render data from the second buffer through a non-protected second context, performing a compositing process on the second render data to obtain a second to-be-displayed image and displaying the second to-be-displayed image on screen.

In some implementations, the protected Surface includes a protected graphics buffer for storing render data of the DRM content; the reading, by the render server, render data of the DRM content from the protected Surface through a protected first context, performing fusion rendering on the render data of the DRM content and a current scene in a same space to obtain first render data and storing the first render data into a protected first buffer includes: generating, by the render server, a drawing command, storing the drawing command to a protected command buffer and placing the drawing command from the protected command buffer into a protected command queue, and reading, by a protected submit module, the drawing command from the protected command queue and submitting the drawing command to a graphics processing unit (GPU) for execution; and reading, by executing the drawing command, render data of the DRM content from the protected graphics buffer, performing fusion rendering on the render data of the DRM content and the current scene in the same space to obtain the first render data, and storing the first render data into the protected first buffer.

In some implementations, the reading, by the compositor, the first render data from the protected first buffer through a protected second context, performing a compositing process on the first render data to obtain a first to-be-displayed image and displaying the first to-be-displayed image on screen includes: reading, by the compositor, the first render data from the protected first buffer through the protected second context, performing the compositing process on the first render data to obtain display data of the first to-be-displayed image and storing the display data of the first to-be-displayed image in a protected third buffer.

In some implementations, the performing, by the render server, fusion rendering on the render data of the DRM content and the current scene in the same space to obtain second render data through a non-protected first context and storing the second render data into a non-protected second buffer when the playback status of the DRM content is abnormal playback includes: generating, by the render server, a drawing command, storing the drawing command to a non-protected command buffer and placing the drawing command from the non-protected command buffer into a non-protected command queue, and reading, by a non-protected submit module, the drawing command from the non-protected command queue and submitting the drawing command to a GPU for execution; and reading, by executing the drawing command, render data of the DRM content from the protected graphics buffer, performing fusion rendering on read content and the current scene in the same space to obtain the second render data and storing the second render data into the non-protected second buffer, wherein the read content is not the render data of the DRM content.

In some implementations, the reading, by the compositor, the second render data from the second buffer through a non-protected second context, performing a compositing process on the second render data to obtain a second to-be-displayed image and displaying the second to-be-displayed image on screen includes: reading, by the compositor, the second render data from the non-protected second buffer through the non-protected second context, performing a compositing process on the second render data, obtaining display data of the second to-be-displayed image and storing the display data of the second to-be-displayed image into a non-protected fourth buffer.

In some implementations, the playback status of the DRM content being abnormal playback includes: the DRM content being in a screen recording status or a screenshotting status.

In some implementations, content in the current scene includes a three-dimensional (3D) desktop, or the current scene includes the 3D desktop and a display panel of at least one other XR application.

In some implementations, the first to-be-displayed image includes the current scene and the DRM content, and the DRM content is superimposed on the current scene; and
the second to-be-displayed image includes the current scene and a playback panel of the DRM content, and the playback panel of the DRM content is superimposed on the current scene, wherein the DRM content is not played on the playback panel of the DRM content.

In some implementations, the playback panel of the DRM content is black.

In a second aspect, embodiments of the present disclosure provide an apparatus for rendering DRM content in an XR device. The apparatus includes:
a render server, configured to render the DRM content onto a protected Surface when the DRM content is displayed by a target XR application, and
the render server is further configured to: read render data of the DRM content from the protected Surface through a protected first context, perform fusion rendering on the render data of the DRM content and a current scene in a same space to obtain first render data and store the first render data into a protected first buffer; and
a compositor, configured to read the first render data from the protected first buffer through a protected second context, perform a compositing process on the first render data to obtain a first to-be-displayed image and display the first to-be-displayed image on screen.

In a third aspect, embodiments of the present disclosure provide an XR device, which includes: a processor and a memory, wherein the memory is configured to store a computer program, the processor is configured to call and run the computer program stored in the memory to perform the method according to the first aspect.

In a fourth aspect, embodiments of the present disclosure provide a computer-readable storage medium for storing a computer program. The computer program is configured to cause a computer to perform the method according to the first aspect.

In a fifth aspect, embodiments of the present disclosure provide a computer program product which includes a computer program. The computer program, when executed by a processor, causes the processor to implement the method according to the first aspect.

In the method and the apparatus for rendering the DRM content in the XR device, the device, and the medium according to the embodiments of the present disclosure, when a target XR application plays the DRM content, the render server renders the DRM content onto a protected Surface; the render server reads render data of the DRM content from the protected Surface through a protected first context, performs fusion rendering on the render data of the DRM content and a current scene in a same space to obtain first render data and stores the first render data into a protected first buffer; and the compositor reads the first render data from the protected first buffer through a protected second context, performs a compositing process on the first render data to obtain a first to-be-displayed image and displays the first to-be-displayed image on screen. According to the method, both the DRM content and a current scene are processed in a protected demand and buffer, a display panel of the DRM content and content of the current scene can be subjected to fusion rendering in the same space, and thus, the DRM content can be displayed in the XR device normally.

### BRIEF DESCRIPTION OF DRAWINGS

In order to explain the technical solutions in the embodiments of the present invention more clearly, the drawings needed in the embodiment description will be briefly introduced below. Apparently, the drawings described below are merely some of embodiments of the invention, and for those of ordinary skills in the art, other drawings can be obtained according to these drawings without any creative effort.

FIG. 1 is a schematic diagram of a display effect of an XR device when a screenshot or a screen recording is taken;

FIG. 2 is a schematic diagram of a software architecture of the XR device in a render mode to which an embodiment of the present disclosure is applicable;

FIG. 3 is a flowchart of a method for rendering a DRM content in an XR device provided by an embodiment of the present disclosure;

FIG. 4 is a flowchart of a method for rendering a DRM content in an XR device provided by an embodiment of the present disclosure.

FIG. 5 is a schematic diagram of a render pass for the DRM content in the XR device;

FIG. 6 is a schematic diagram of a render pass for a non-DRM content in the XR device;

FIG. 7 is a structural schematic diagram of an apparatus for rendering a DRM content in an XR device provided by an embodiment of the present disclosure; and

FIG. 8 is a structural schematic diagram of an XR device provided by an embodiment of the present disclosure.

### DETAILED DESCRIPTION

Below, the technical solutions in the embodiments of the present invention will be clearly and completely described in conjunction with the accompanying drawings. Obviously, the described embodiments are only a part of the embodiments of the present invention, not all of them. Based on the embodiments of the present invention, all other embodiments obtained by ordinary skilled persons in the art without creative labor are within the scope of protection of the present invention.

It should be noted that the terms “first”, “second”, etc. in the present disclosure and accompanying drawings are used to distinguish similar objects and do not necessarily need to be used to describe a specific order or sequence. It should be understood that the data used in this way can be interchanged in appropriate circumstances, so that the embodiments of the present invention described herein can be implemented in order other than those illustrated or described herein. In addition, the terms “including” and “having”, as well as any variations thereof, are intended to cover non-exclusive inclusions, such as processes, methods, systems, products, or servers that contain a series of steps or units that are not necessarily limited to those clearly listed, but may include other steps or units that are not clearly listed or inherent to these processes, methods, products, or devices.

In order to facilitate the understanding of embodiments of the present disclosure, before describing each embodiment of the present disclosure, some concepts involved in all embodiments of the present disclosure will be appropriately explained as follows.

1) virtual reality (VR): a technology for creating and experiencing a virtual world, which determines and generates a virtual environment and integrates multi-source information (virtual reality mentioned herein includes at least visual perception, as well as auditory perception, tactile perception, motion perception, even taste perception, smell perception, etc.) to realize the simulation of a fused and interactive three-dimensional dynamic scene and physical behaviors of a virtual environment, so that users can be immersed into the simulated virtual reality environment. It has found its applications in a variety of virtual environments such as maps, games, videos, education, medical care, simulation, collaborative training, sales, assistance in manufacturing, maintenance and repair.

2) virtual reality device (VR device): a device for achieving a virtual reality effect, which can usually be provided in the form of glasses and a head mount display (HMD) for implementing visual perception and other forms of perception. Of course, the implementation form of the virtual reality device is not limited to this, and it can be further miniaturized or enlarged according to actual needs.

Optionally, the virtual reality devices described in the embodiments of the present disclosure may include, but are not limited to, the following types:
2.1) personal computer virtual reality (PCVR) device: which uses a personal computer (PC) to carry out related calculation and data output of virtual reality functions, where an external personal computer virtual reality device uses the data outputted by the PC to realize the effect of virtual reality.
2.2) mobile virtual reality device: which supports setting a mobile terminal (such as a smartphone) in various ways (such as a head-mounted display provided with a special card slot), such that the mobile terminal performs related calculations of virtual reality functions through a wired or wireless connection with the mobile virtual reality device and outputs data to the mobile virtual reality device. For example, a user can watch a virtual reality video through an APP of the mobile terminal.
2.3) all-in-one virtual reality device: which is provided with a processor for performing related calculations of virtual functions and thus has independent virtual reality input and output functions without being connected with the PC or the mobile terminal, and has a high degree of freedom in use.

3) virtual field of view: an area in a virtual environment that can be perceived by a user through a lens in a virtual reality device, the perceived area being represented by a field of view (FOV) of the virtual field of view.

4) augmented reality (AR): a technology for calculating pose parameters of a camera in a reality world (or a three-dimensional world, a physical world) in real time in an image acquisition process of the camera and adding virtual elements to an image acquired by the camera according to the camera pose parameters. Virtual elements include, but are not limited to: images, videos, and 3D models. A goal of the AR technology is to connect the virtual world on a screen to the real world for interaction.

5) mixed reality (MR): a simulated setting that integrates computer-created sensory inputs (e.g., a virtual object) with sensory inputs from a physical setting or a representation thereof. In some MR sets, the computer-created sensory inputs may be adapted to changes in the sensory inputs from the physical setting. Additionally, some electronic systems for presenting the MR setting may monitor an orientation and/or a location relative to the physical setting to enable the virtual object to interact with a real object (i.e., a physical element from the physical setting or a representation thereof). For example, the system may monitor motion such that a virtual plant appears to be stationary relative to a physical building.

6) extended reality (XR): which refers to all real and virtual combined environments and human-computer interactions generated by a computer technology and a wearable device, including virtual reality (VR), augmented reality (AR) and mixed reality (MR) and other forms.

7) virtual scene: which is displayed (or provided) by an application program when running on an electronic device. The virtual scene may be a simulation environment of the physical world, a semi-simulated and semi-fictional virtual scene, or a pure fictional virtual scene. The virtual scene may be any one of a two-dimensional virtual scene, a 2.5-dimensional virtual scene, or a three-dimensional virtual scene, and dimensions of the virtual scene are not limited in the embodiment of the present disclosure. For example, the virtual scene may include sky, land, sea, etc., the land may include environmental elements such as desert, cities, etc., and the user may control the virtual object to move in the virtual scene.

8) virtual object: which is an object that interacts in the virtual scene, is controlled by a user or a robot program (for example, an artificial intelligence-based robot program), and can be stationary, move, and perform various behaviors in the virtual scene, such as various characters in a game.

In actual scenarios, the user may open multiple XR applications, the multiple XR applications can run at the same time, and display panels of the multiple XR applications can be displayed on a 3D desktop (or a 3D space, an XR space) of the XR device at the same time. In the same scene, it is usually expected that render data (or a render content) of the multiple applications interact with each other spatially to result in some special effects, for example, how to make an occluded area more visually natural when there is an occlusion between panels or models of two applications.

When playing a DRM content on the XR device, the XR application playing the DRM content may need to interact with an XR environment and other XR applications. According to the characteristics of the DRM content, the user usually expects to see the following playback effects: (1) the DRM content can be played and displayed normally in the XR device; (2) when the DRM content is in abnormal playback situations such as a screen recording, a screenshot, etc., a playback area of the DRM content is black, but other areas are displayed normally.

FIG. 1 is a schematic diagram of a display effect of the XR device during the screenshot or the screen recording. As shown in FIG. 1, a display panel (or a playback panel) of the DRM content is located in a central area of a current scene, and the current scene is displayed normally; while the display panel of the DRM content is a black area, and the user cannot see the DRM content, such that the DRM content is protected. The current scene in FIG. 1 refers to an XR scene where the playback panel of the DRM content is located.

Related rendering methods cannot be directly applied to the playback of the DRM content, this result in the above playback effect, which is because of the fact that the render data of the playback panel of the DRM content needs to be stored in a protected buffer. Based on this, an embodiment of the present disclosure provides a method for rendering a DRM content in an XR device, where the DRM content has a better playback effect on the XR device by performing fusion rendering on the DRM content and the current scene.

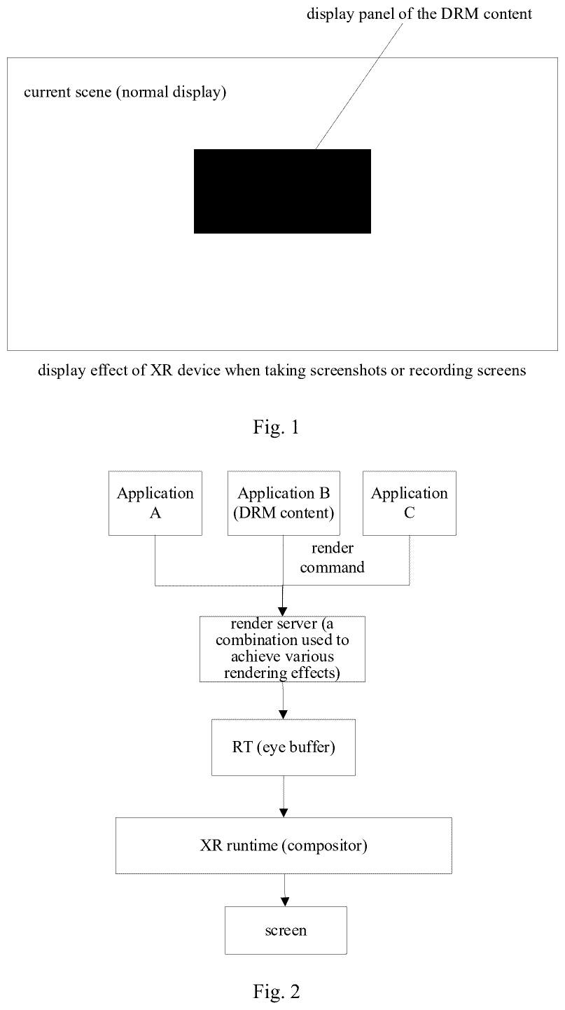

FIG. 2 is a schematic diagram of a software architecture of the XR device in a render mode to which an embodiment of the present disclosure is applicable. As shown in FIG. 2, the software architecture mainly includes three layers: an application layer, a render layer and XR runtime, where an XR application runs in the application layer.

The render server is located in the render layer and is used for rendering each XR application on the XR device through a render engine, and storing render data to a render target (RT). The render server is a service module independent of the XR application, located between the XR application and XR runtime.

The XR runtime is a core component of an XR technology and can be regarded as an operating system of the XR device. It carries key algorithms of XR and serves as a bridge to connect the application and the XR device. A compositor is located in the XR runtime and is configured to read render data from the RT and perform a compositing process on the render data, and send a composited to-be-displayed image to a display device for displaying.

Taking FIG. 2 as an example, the user opens an application A, an application B and an application C, the DRM content is played on the application B, the application A, the application B and the application C respectively send render instructions to the render server, and the render server simultaneously performs fusion rendering on display panels of the application A, the application B and the application C in a same space according to the render instructions to complete the combination of various render effects, and stores final render data in one RT. The render server completes the combination of various display effects of the display panels of the application A, the application B and the application C in the space through fusion rendering. The compositor reads render data from the RT, performs a compositing process on the render data to obtain a to-be-displayed image, and sends the to-be-displayed image to the display device for displaying on the screen.

In the render engine, RT can be understood as a buffer, which is used for storing a render result of the render server. The render server performs fusion rendering on a plurality of XR applications in a same space at the same time, render contents of the plurality of XR applications can influence each other to produce various render effects, the various render effects are combined such that render data of different applications can influence each other more naturally.

Hereinafter, the technical solutions of the present disclosure will be described in detail by some embodiments. The embodiments described below may be combined with each other, and the same or similar concepts or processes may not be described in detail within certain embodiments.

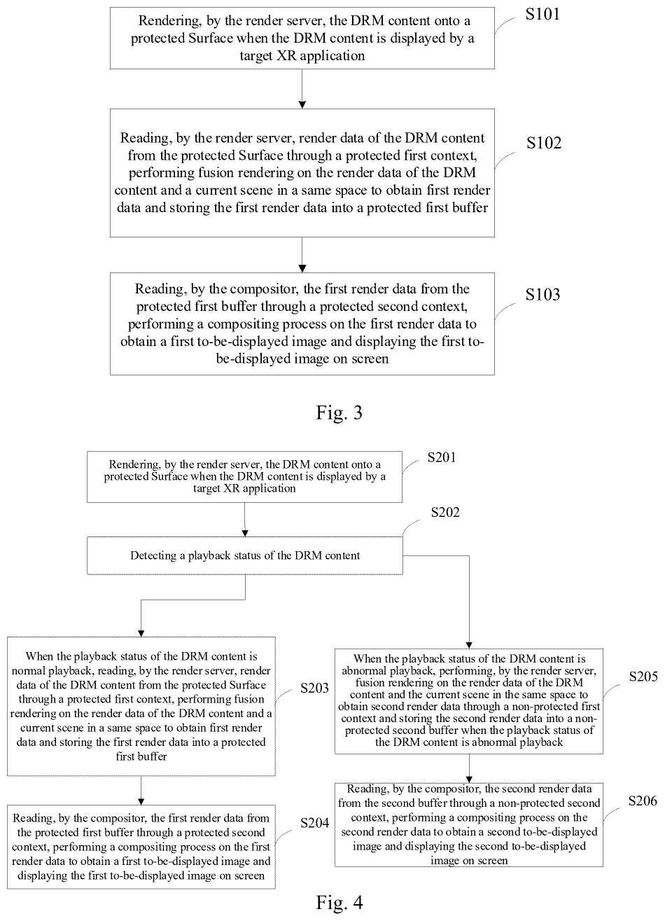

FIG. 3 is a flowchart of a method for rendering a DRM content in an XR device provided by an embodiment of the present disclosure. The method of the embodiments is executed by the XR device having a render server and a compositor running therein. As shown in FIG. 3, the method provided by the embodiments includes the following steps.

S101: rendering, by the render server, the DRM content onto a protected Surface when a target XR application plays the DRM content.

The target XR application is an XR application that plays the DRM content. The target XR application will send a drawing instruction to the render server, instructing the render server to render the target XR application. After receiving the render instruction sent by the XR application, the render server determines whether the played video is the DRM content based on the render instruction.

Optionally, the render instruction may carry a type of the playback content, and the type of the playback content is used for indicating whether the playback content is a DRM content or a non-DRM content, where the non-DRM content is also referred to as a normal content.

The DRM content may be a DRM video, a DRM audio, a DRM picture, a DRM document, a DRM electronic book, or the like.

When the render server detects that the DRM content is played in the XR device, the render server creates a protected render environment, which can also be called a render pass. The render pass consists of a complete render process and resources used, the render process includes various commands used for rendering, and the resources used for rendering include, but are not limited to, various buffers for storing render data.

After a protected render pass is created, both the protected render pass and a non-protected render pass may exist in the system of the XR device, where the non-protected render pass is used for rendering the non-DRM content. The protected render pass can enable the protection of the DRM content through cooperation of hardware and the system of the XR device.

In the embodiments, for the DRM content, the render server will create a protected Surface. In the Android system, Surface is an abstraction of a background buffer and is a memory area shared between the application and Surface Flinger. Surface is real canvas in Android, and all the user interface (UI) on Activity is drawn on Surface.

The render server draws the DRM content to the protected Surface, and the Surface includes one or more graphic buffers where the render data of the DRM content is actually stored.

S102: reading, by the render server, render data of the DRM content from the protected Surface through a protected first context, performing fusion rendering on the render data of the DRM content and a current scene in a same space to obtain first render data and storing the first render data into a protected first buffer.

The render server creates a protected render pass, including creating a protected Surface and a protected context. The context includes global information related to an environment of the application, including but not limited to memory allocation, command storage, command execution and a render pipeline, etc. The render server renders the DRM content to the current scene through a protected first context to complete the fusion of the DRM content and the current scene.

The render server uses an existing drawing application programming interface (API) to render the DRM content to the current scene, that is, completing the fusion rendering of the DRM content and the content of the current scene.

Optionally, the render server uses Vulkan to render the DRM content to the current scene. Vulkan is a cross-platform 2D and 3D drawing API. Vulkan supports multithreading.

In Vulkan, the protected first context mainly includes a protected command buffer, a protected command queue, and a protected submit module.

Exemplarily, the render server generates a drawing command, stores the drawing command to a protected command buffer and places the drawing command from the protected command buffer into a protected command queue, and a protected submit module reads the drawing command from the protected command queue and submits the drawing command to a graphics processing unit (GPU) for execution.

The drawing command is a general term of various commands involved in the render process, and the drawing command is transferred through the protected command buffer, the protected command queue and the protected submit module to protect the drawing command. The GPU is the actual executor of the drawing command, and reads render data of the DRM content from the protected graphics buffer by executing the drawing command, performs fusion rendering on the render data of the DRM content and the current scene in the same space to obtain the first render data, and stores the first render data into the protected first buffer.

The protected graphics buffer is located in the protected Surface, the first buffer is also called an eye buffer or the RT described above, the eye buffer is used for storing eye render data of the XR application, the eye buffer may include a left eye buffer and a right eye buffer, the left eye buffer is used for storing render data corresponding to the left eye, and the right eye buffer is used for storing render data corresponding to the right eye.

In the embodiments, the render server performs fusion rendering on the render data of the DRM content with the left eye data of the current scene and the right eye data of the current scene respectively through the protected first context to obtain the render data corresponding to the left eye and the render data corresponding to the right eye, and the render data corresponding to the left eye and the render data corresponding to the right eye are fusion results of the display panel of the DRM content and the current scene.

In the embodiments, the render server adopts a pre-compositing method to perform fusion rendering on the DRM content and the current scene in the same space into the same RT. Compared with a method in which the render server renders the DRM content and the current scene respectively, the display panel of the DRM content and the content of the current scene are simply combined in the compositor, the pre-compositing method can perform more render operations on the DRM content and the current scene in the space more naturally.

S103: reading, by the compositor, the first render data from the protected first buffer through a protected second context, performing a compositing process on the first render data to obtain a first to-be-displayed image and displaying the first to-be-displayed image on screen.

The second context may be an OpenGL Context, various drawing commands of the compositor act on the second context, and the compositor reads the first render data from the protected first buffer through the protected first context, performs a compositing process on the first render data to obtain the first to-be-displayed image, and stores display data of the first to-be-displayed image in the protected third buffer.

The compositing process includes compositing a plurality of layers or compositing layers included in the first render data, and further includes distortion processing of an image, and the like, and an image finally used for displaying on the screen is generated by processing by the compositor. The first to-be-displayed image includes a left eye image and a right eye image, and the compositor performs a compositing process on the left eye image and the right eye image, respectively.

The protected third buffer is used for storing the image for displaying, and the XR runtime reads display data of the first to-be-displayed image from the protected third buffer, and performs the displaying on the screen.

The first to-be-displayed image includes a DRM content and a current scene, and the DRM content is superimposed on the current scene, where the content in the current scene includes a 3D desktop, or includes a 3D desktop and a display panel of at least one other XR application.

In response to the current scene including the 3D desktop and at least one other XR application, when the render server fuses the display panel of the DRM content and the current scene, the render server puts the display panel of the DRM content, the display panels of other XR applications and the 3D desktop in one space as a whole for rendering fusion, such that various complex render effects, rather than just a combination of panel locations, can be realized.

Through fusion rendering, multiple XR applications (including the DRM content) in the current scene can also interact with each other, for example, a virtual object in a display panel of a first XR application is dragged to a display panel of a second XR application, and locations of the display panels of the two XR applications can also be flexibly moved.

In the embodiments, for the rendering of the DRM content, Surface created by the render server is a protected Surface, and the created context is a protected first context.

In an implementation, the render server performs fusion rendering on the DRM content and the current scene in the same space through the protected first context, and stores the first render data into the protected Surface. The render server writes the first render data from the protected Surface into the protected first buffer through a protected drawing instruction.

Through the protected render pass, both the DRM content and the current scene are operated in the protected instruction and buffer, such that the display panel of the DRM content and the content of the current scene can be fused, and the DRM content can be normally displayed in the current scene.

In the embodiments of the present disclosure, when the target XR application plays the DRM content, the render server renders the DRM content and stores the render data of the DRM content into the protected Surface; and the render server reads render data of the DRM content from the protected Surface through a protected first context, performs fusion rendering on the render data of the DRM content and a current scene in a same space to obtain first render data and stores the first render data into a protected first buffer; and the compositor reads the first render data from the protected first buffer through a protected second context, performs a compositing process on the first render data to obtain a first to-be-displayed image and displays the first to-be-displayed image on screen. According to the method, both the DRM content and a current scene are processed in a protected demand and buffer, a display panel of the DRM content and content of the current scene can be subjected to fusion rendering in the same space, thus, the DRM content can be played by the XR device in a better effect.

In the embodiments, the DRM content and the data of the current scene are stored in the protected buffer in processes of rendering and displaying on the screen, and when the DRM is normally played, the XR device can display the DRM content in the current scene in a fusion manner. When the DRM content is screen-recorded or screenshotted, since the data storage of the current scene is also stored in the protected buffer, neither the current scene nor the DRM content can be recorded; exemplarily, when the DRM content is screen-recorded or screenshotted, both an area of the current scene and an area of the DRM content displayed in a black.

In some circumstances, when the user expects the DRM content to be screen-recorded or screenshotted, the current scene can be recorded normally, and it only needs to protect the DRM content. Accordingly, an embodiment of the present disclosure provides a method for rendering, where the render server detects a playback status of the DRM content before performing fusion rendering on the render data of the DRM content and the current scene in the same space through a protected first context; and the render server performs fusion rendering on the render data of the DRM content and the current scene in the same space through the protected first context when the playback status of the DRM content is normal playback. When the playback status of the DRM content is abnormal playback, the DRM content and the current scene are rendered through the non-protected render pass, and the specific description thereof refers to the description in the embodiments of the present disclosure.

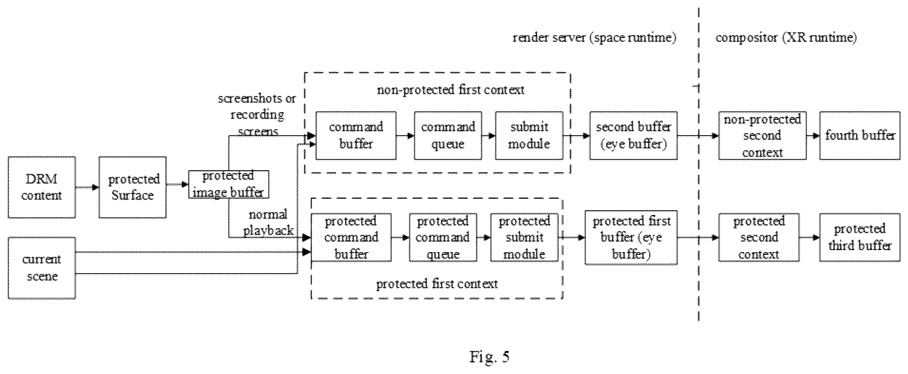

FIG. 4 is a flowchart of a method for rendering a DRM content in an XR device provided by an embodiment of the present disclosure, and FIG. 5 is a schematic diagram of a render pass for the DRM content in the XR device. With reference to FIGS. 4 and 5, the method provided by the present embodiment may include the following steps.

S201: rendering, by the render server, the DRM content onto a protected Surface when the DRM content is displayed by a target XR application.

With reference to FIG. 5, an operating environment of the XR device is divided into: space runtime and the XR runtime, and the render server is located at the a space runtime side and the compositor is located at the XR runtime side.

When detecting that the DRM content is played, the render server triggers the establishment of the protected render pass and the non-protected render pass in FIG. 5, where the protected render pass consists of a protected Surface, a protected image buffer, a protected command buffer, a protected command queue, a protected submit module, a protected first buffer, a protected second context, and a protected third buffer.

The non-protected render pass consists of a protected Surface, a protected image buffer, a non-protected command buffer, a non-protected command queue, a non-protected submit module, a non-protected first buffer, a non-protected second context, and a non-protected fourth buffer.

After triggering the establishments of the protected render pass and the non-protected render pass, the render server starts rendering the DRM content first, and stores render data of the DRM content into the protected Surface, the protected Surface includes one or more protected image buffers which are used for storing render data of the DRM content.

S202: detecting a playback status of the DRM content.

The render server detects the playback status of the DRM content. Step S203 is executed when the playback status of the DRM content is normal playback, and step S205 is executed when the playback status of the DRM content is abnormal playback.

S203: when the playback status of the DRM content is normal playback, reading, by the render server, render data of the DRM content from the protected Surface through a protected first context, performing fusion rendering on the render data of the DRM content and a current scene in a same space to obtain first render data and storing the first render data into a protected first buffer.

The first context includes the protected command buffer, the protected command queue and the protected submit module in FIG. 5, and the render server fuses and renders the render data of the DRM content onto the current scene through the drawing command and the protected first context, and completes all render effects of the DRM content and the current scene in the space.

S204: reading, by the compositor, the first render data from the protected first buffer through a protected second context, performing a compositing process on the first render data to obtain a first to-be-displayed image and displaying the first to-be-displayed image on screen.

The second context may be the OpenGL context, and the second context is used for rendering the first render data in the first buffer onto the screen. The compositor stores the display data of the processed first to-be-displayed image in the third buffer, and the screen reads data from the third buffer for display.

Specific implementations of steps S203 to S204 refer to the related description of the above embodiments, which are not repeated here.

S205: performing, by the render server, fusion rendering on the render data of the DRM content and the current scene in the same space to obtain second render data through a non-protected first context and storing the second render data into a non-protected second buffer when the playback status of the DRM content is abnormal playback.

The playback status of the DRM content being abnormal playback includes: when the DRM content is in a screen recording status or a screenshotting status. The application may monitor whether a screenshotting operation or a screen recording operation occurs to the DRM content, and when it is detected that the screenshotting operation or the screen recording operation occurs, the render server is notified that the screenshotting or screen recording operation occurs to the DRM content, and the render server determines that the abnormal playback has occurred according to a notification from the application.

The non-protected first context is relative to the protected first context, and the difference therebetween is that the protected context is obtained by performing a protection operation on the non-protected first context by some protection methods, and the non-protected first context can be understood as a normal context, which is used for rendering the non-DRM content and the current scene. The protected first context renders the DRM content and the current scene, and the protection methods for the DRM content include, but are not limited to, an encryption algorithm, hardware protection, and the like.

Since the DRM content needs to be processed in a protected environment, during screen recording or screenshotting, the render data of the DRM content is read from the protected graphics buffer by using the non-protected first context, the non-protected first context cannot read the render data of the DRM content from the protected graphics buffer, or it is understood that the content read by the non-protected first context from the protected graphics buffer is not the render data of the DRM content, and the content read by the non-protected first context from the protected graphics buffer can be understood as a blank content or preset render data, which preset render data may be render data of a black area or render data of a preset image unrelated to the DRM content.

During screen recording or screenshotting, the render server cannot read the render data of the DRM content through the non-protected first context, but can normally render the content of the current scene, and the render server performs fusion rendering in the same space based on the content read from protected graphics buffer and the current scene to obtain the second render data. The current scene in the display image corresponding to the second render data obtained in this manner can be displayed normally, but the content displayed on the display panel of the DRM content is not the DRM content, so that the DRM content is protected. When the current scene is rendered through the non-protected first context, or fusion rendering is performed on the current scene and the preset render data, the data of the current scene is non-protected.

When the DRM content is normally played, the render server reads the render data of the DRM content from the protected graphics buffer through the protected first context, performs fusion rendering on the read render data of the DRM content and the current scene through the protected first context to obtain the first render data, and stores the first render data into the protected first buffer. When fusion rendering is performed on the render data of the DRM content and the current scene through the protected first context, the data of the current scene is protected as well as the render data of the DRM content.

The render server can use VulkanAPI to implement the fusion rendering of DRM render data and the current scene. VulkanAPI supports the protected context and the non-protected context. With reference to FIG. 5, the non-protected first context includes the non-protected command buffer, the non-protected command queue and the non-protected submit module.

The render server generates a drawing command, stores the drawing command to a non-protected command buffer and places the drawing command from the non-protected command buffer into a non-protected command queue, and the non-protected submit module reads the drawing command from the non-protected command queue and submits the drawing command to the GPU for execution.

By executing the drawing command, the render data of the DRM content is read from the protected graphics buffer, fusion rendering is performed on a read content and the current scene in the same space to obtain the second render data. The second render data is stored into the non-protected second buffer, where the read content is not the render data of the DRM content.

The non-protected second buffer is a non-protected eye buffer, that is, a normal eye buffer, and the non-protected eye buffer includes a left eye buffer and a right eye buffer, which are used for storing render data of the left eye and render data of the right eye, respectively.

S206: reading, by the compositor, the second render data from the second buffer through a non-protected second context, performing a compositing process on the second render data to obtain a second to-be-displayed image and displaying the second to-be-displayed image on screen.

The non-protected second context may be a non-protected OpenGL context, and the compositor reads the second render data from the non-protected second buffer through the non-protected second context, performs a compositing process on the second render data, obtains display data of the second to-be-displayed image and stores the display data of the second to-be-displayed image into a non-protected fourth buffer. The non-protected fourth buffer is used for storing the image for displaying on the screen, and the screen reads display data of the second to-be-displayed image from the non-protected fourth buffer and displays it.

The second to-be-displayed image includes the current scene and a playback panel of the DRM content, and the playback panel of the DRM content is superimposed and displayed on the current scene, where the playback panel of the DRM content does not display the DRM content, and the content of the current scene is displayed normally. Thus, in the case of screen recording and screenshotting, the DRM content can be protected while normal screen recording and screenshotting of the current scene are performed.

The DRM content is not displayed on the playback panel of the DRM content, but some other images can be displayed on the playback panel of the DRM content. For example, a black image can be displayed on the playback panel of the DRM content, as shown in FIG. 1, or a white image or any other image unrelated to the DRM content can be displayed on the playback panel of the DRM content.

In the embodiments, when the DRM content is normally played, the DRM content and the current scene are subjected to fusion rendering through the protected render pass, and displayed on screen. When the DRM content is in an abnormal playback status such as screen recording and screenshotting, if fusion rendering is performed on the DRM content and the current scene through the non-protected render pass, the render data of the DRM content cannot be obtained in the non-protected path, such that the render data of the DRM content and the current scene cannot be fused and rendered, but the current scene can be rendered. In such a way, the display panel of the DRM content can be displayed in the current scene, but the display panel does not display the DRM content, thus protecting the DRM content.

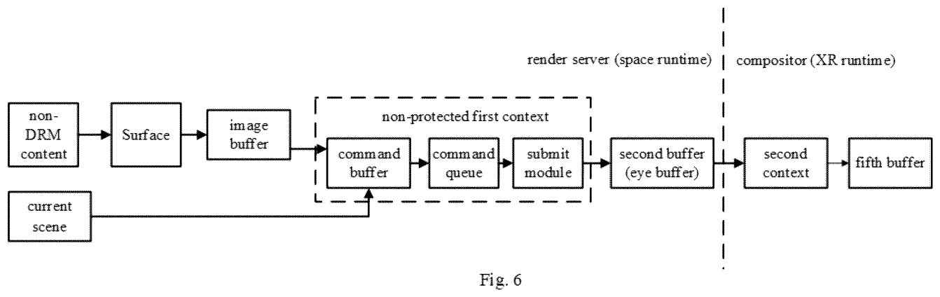

The above embodiment describes the render process of the DRM content in the XR device, in which not only the DRM content but also the non-DRM content is played. FIG. 6 is a schematic diagram of a render pass for the non-DRM content in the XR device. As shown in FIG. 6, for the non-DRM content, the normal render pass is taken, the render server first renders the non-DRM content onto the Surface which is a non-protected Surface, then reads the render data of the non-DRM content from the image buffer of the Surface through the non-protected first context, performs fusion rendering on the render data of the non-DRM content and the current scene in the same space to obtain third render data, and stores the third render data in the non-protected eye buffer. When the render server performs fusion rendering on the render data of the non-DRM content and the current scene using the non-protected first context, both the render data of the non-DRM content and the data of the current scene are in a non-protected status. Finally, the compositor reads the third render data from the eye buffer through the non-protected second context, perform a compositing process on the third render data to obtain a third display image, and stores the third display image in a fifth buffer, and the screen reads display data of the third display image from the fifth buffer for displaying on the screen.

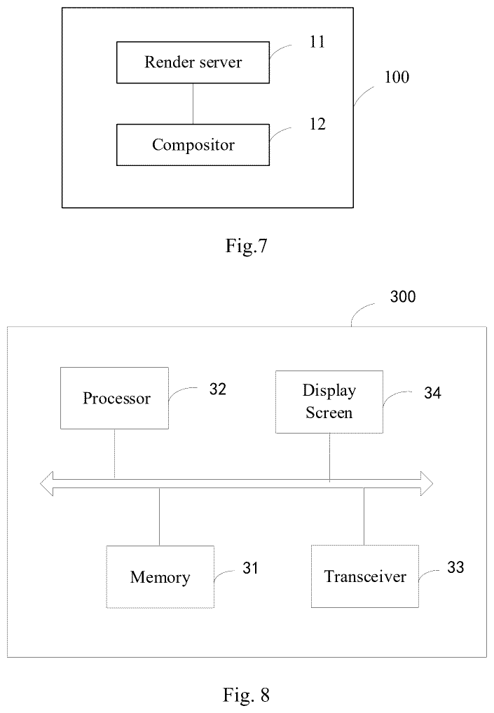

In order to facilitate better implementation of the method for rendering the DRM content in the XR device according to the embodiment of the present disclosure, an embodiment of the present disclosure further provides an apparatus for rendering a DRM content in an XR device. FIG. 7 is a structural schematic diagram of an apparatus for rendering a DRM content in an XR device provided by an embodiment of the present disclosure. As shown in FIG. 7, the apparatus 100 for rendering the DRM content in the XR device includes:
a render server 11 configured to render the DRM content onto a protected Surface when a target XR application plays the DRM content;
the render server 11 being further configured to read render data of the DRM content from the protected Surface through a protected first context, perform fusion rendering on the render data of the DRM content and a current scene in a same space to obtain first render data and store the first render data into a protected first buffer; and
a compositor 12 configured to read the first render data from the protected first buffer through a protected second context, perform a compositing process on the first render data to obtain a first to-be-displayed image and display the first to-be-displayed image on screen.

In an exemplary embodiment, before performing fusion rendering on render data of the DRM content and the current scene in a same space through the protected first context, the render server 11 is further configured to:
detect a playback status of the DRM content; and
perform fusion rendering on the render data of the DRM content and the current scene in the same space through the protected first context when the playback status of the DRM content is normal playback.

In an exemplary embodiment, the render server 11 is further configured to:
perform fusion rendering on the render data of the DRM content and the current scene in the same space to obtain second render data through a non-protected first context and storing the second render data into a non-protected second buffer when the playback status of the DRM content is abnormal playback; and
the compositor 12 is further configured to: read the second render data from the second buffer through a non-protected second context, perform a compositing process on the second render data to obtain a second to-be-displayed image and display the second to-be-displayed image on screen.

In an exemplary embodiment, the protected Surface includes a protected graphics buffer for storing the render data of the DRM content;
and the render server 11 is specifically configured to: generate a drawing command, store the drawing command to a protected command buffer and place the drawing command from the protected command buffer into a protected command queue, and read, by a protected submit module, the drawing command from the protected command queue and submit the drawing command to a GPU for execution; and
read, by executing the drawing command, render data of the DRM content from the protected graphics buffer, perform fusion rendering on the render data of the DRM content and the current scene in the same space to obtain the first render data, and store the first render data into the protected first buffer.

In an exemplary embodiment, the compositor 12 is specifically configured to: read the first render data from the protected first buffer through the protected second context, perform a compositing process on the first render data to obtain display data of the first to-be-displayed image and store the display data of the first to-be-displayed image in a protected third buffer.

In an exemplary embodiment, the performing, by the render server 12, fusion rendering on the render data of the DRM content and the current scene in the same space to obtain second render data through a non-protected first context and storing the second render data into a non-protected second buffer when the playback status of the DRM content is abnormal playback includes:
generating a drawing command, storing the drawing command to a non-protected command buffer and placing the drawing command from the non-protected command buffer into a non-protected command queue, and reading, by a non-protected submit module, the drawing command from the non-protected command queue and submitting the drawing command to the GPU for execution; and
reading, by executing the drawing command, the render data of the DRM content from the protected graphics buffer, performing fusion rendering on a read content and the current scene in the same space to obtain the second render data and storing the second render data into the non-protected second buffer, where the read content is not the render data of the DRM content.

In an exemplary embodiment, the reading, by the compositor 12, the second render data from the second buffer through a non-protected second context, performing a compositing process on the second render data to obtain a second to-be-displayed image and displaying the second to-be-displayed image on screen includes:
reading the second render data from the non-protected second buffer through the non-protected second context, performing a compositing process on the second render data, obtaining display data of the second to-be-displayed image and storing the display data of the second to-be-displayed image into a non-protected fourth buffer.

In an exemplary embodiment, the playback status of the DRM content being abnormal playback includes: the DRM content being in a screen recording status or a screenshotting status.

In an exemplary embodiment, the content in the current scene includes a three-dimensional (3D) desktop, or the current scene includes the 3D desktop and the display panel of at least one other XR application.

In an exemplary embodiment, the first to-be-displayed image includes the current scene and the DRM content, and the DRM content is superimposed on the current scene; and
the second to-be-displayed image includes the current scene and a playback panel of the DRM content, and the playback panel of the DRM content is superimposed and displayed on the current scene, where the DRM content is not played on the playback panel of the DRM content.

In an exemplary embodiment, the playback panel of the DRM content is black.

It is to be understood that the apparatus embodiment and the method embodiment may correspond to each other, and similar description may refer to the method embodiment. To avoid repetition, details will not be described here.

The apparatuses 100 of the embodiments of the present disclosure have been described above from the perspective of functional modules in conjunction with the drawings. It is to be understood that the functional modules may be implemented in a form of hardware, in a form of instructions of software, or in a combination of hardware and software modules. Specifically, the various steps of the method embodiments among the embodiments of the present disclosure may be completed by an integrated logic circuit of hardware and/or an instruction in the form of software in the processor, and the steps of the method disclosed in combination with the embodiments of the present disclosure may be directly performed and completed by a hardware decoding processor, or may be performed and completed by using a combination of hardware and software modules in the decoding processor. Optionally, the software module may be located in a storage medium that is mature in the art, such as a random-access memory (RAM), a flash memory, a read-only memory (ROM), a programmable ROM, an electrically erasable programmable memory, or a register. The storage medium is located in the memory. The processor reads information in the memory and completes the steps of the foregoing method embodiments in combination with hardware thereof.

An embodiment of the present disclosure also provides an XR device. FIG. 8 is a structural schematic diagram of an XR device provided by an embodiment of the present disclosure. As shown in FIG. 8, the XR device 300 may include:
a memory 31 and a processor 32, where the memory 31 is configured to store a computer program and transmit program codes to the processor 32. In other words, the processor 32 may call and run the computer program from the memory 31 to implement the method in the embodiments of the present disclosure.

For example, the processor 32 may be configured to perform the method steps performed by the XR device in the method embodiments described above in accordance with instructions in the computer program.

In some embodiments of the present disclosure, the processor 32 may include, but is not limited to:

a general-purpose processor, a digital signal processor (DSP), an application specific integrated circuit (ASIC), a field programmable gate array (FPGA), or other programmable logic devices, discrete gate or transistor logic devices, and discrete hardware components, etc.

In some embodiments of the present disclosure, the memory 31 includes, but is not limited to:
a volatile memory and/or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random-access memory (RAM) serving as an external cache. By way of illustration, but not limitation, many forms of RAMs are available, such as a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synch link dynamic random-access memory (SLDRAM) and a direct memory bus random access memory (DR RAM).

In some embodiments of the present disclosure, the computer program may be divided into one or more modules, and the one or more modules are stored in the memory 31 and executed by the processor 32 to complete the method provided by the present disclosure. The one or more modules may be a series of computer program instruction segments that can complete specific functions, and the instruction segments are used for describing an execution process of the computer program in the XR device.

As shown in FIG. 8, the XR device 300 may further include: a transceiver 33, a display screen 34, etc., and the processor 32 is electrically connected to the transceiver 33 and the display screen 34, respectively.

Here, the processor 32 may control the transceiver 33 to communicate with other devices, specifically, may transmit information or data to other devices, or receive information or data transmitted by other devices. The transceiver 33 may include a transmitter and a receiver. The transceiver 33 may further include antennas, and a number of the antennas may be one or more.

The display screen 34 may be used for displaying a graphical user interface and receiving operation instructions generated by a user acting on a graphical user interface. The display screen 34 may be a touch display screen, and the touch display screen may include a display panel and a touch panel. The display panel may be used for displaying information inputted by or provided to the user and various graphical user interfaces of a computer device, which graphical user interfaces may be composed of graphics, texts, icons, videos and any combination thereof. Optionally, the display panel may be configured in the form of a liquid crystal display (LCD), an organic light-emitting diode (OLED), or the like. The touch panel can be used for collecting touch operations of the user on or near the touch panel (for example, operations by the user on or near the touch panel using any suitable object or accessory such as a finger or a stylus), generating corresponding operation instructions, and executing corresponding programs. Optionally, the touch panel may include two parts: a touch detection apparatus and a touch controller. The touch detection apparatus detects a touch orientation of the user, detects a signal brought by the touch operation, and transmits the signal to the touch controller; and the touch controller receives touch information from the touch detection apparatus, converts the touch information into contact coordinates, and sends the contact coordinates to the processor 32, and can receive and execute the commands sent by the processor 32. The touch panel may overlay the display panel, and when the touch panel detects a touch operation on or near it, the touch panel transmits the touch operation to the processor 32 to determine a type of the touch event, and then the processor 32 provides a corresponding visual output on the display panel according to the type of the touch event.

It can be understood that a structure of the electronic device shown in FIG. 8 does not constitute a limitation of the electronic device, and the electronic device may include more or fewer components than shown, or a combination of certain components, or an arrangement of different components. For example, the electronic device 300 may further include a camera module, a wireless fidelity (WIFI) module, a positioning module, a Bluetooth module, a display, a controller, and the like, and the description thereof is omitted here.

It is to be understood that various components in the XR device are connected through a bus system, where in addition to a data bus, the bus system may further include a power bus, a control bus and a status signal bus.

The present disclosure further provides a computer storage medium, having a computer program stored thereon, the computer program, when executed by a computer, causing the computer to perform the method executed by the XR device in the above-described method embodiment, and the description thereof is omitted here.

The present disclosure also provides a computer program product including a computer program stored in a computer-readable storage medium. The processor of the XR device reads the computer program from the computer-readable storage medium, and the processor executes the computer program such that the XR device executes the method in the above-described method embodiment, which is omitted here.

In the embodiments provided in the present disclosure, it should be understood that the disclosed systems, devices, and methods can be implemented in other ways. For example, the above-described embodiments of the device or apparatus are only illustrative. For example, the division of the module is only a logical function division. In practical implementation, there may be other division methods, such as multiple modules or components being combined or integrated into another system, or some features being ignored or not executed. On the other hand, the mutual coupling or direct coupling or communication connection displayed or discussed can be indirect coupling or communication connection through some interface, device or module, which can be electrical, mechanical or other forms.

The modules described as separate components may or may not be physically separated, and the components displayed as modules may or may not be physical modules, that is, they can be located in one place or distributed across multiple network units. Some or all of the modules can be selected according to actual needs to achieve the purpose of the embodiments. For example, the functional modules in various embodiments of the present disclosure can be integrated into one processing module, or each module can exist separately physically, or two or more modules can be integrated into one module.

The above are only specific implementations of the present disclosure, the scope of protection of the present disclosure is not limited to this. Any skilled person familiar with the technical field can easily achieve changes or replacements within the technical scope disclosed in the present disclosure, which should be included in the scope of protection of the present disclosure. Therefore, the scope of protection of the present disclosure should be based on the scope of protection of the claims.

1. A method for rendering digital rights management (DRM) content in an extended reality (XR) device, wherein the method is applied to the XR device having a render server and a compositor running thereon, and the method comprises:
rendering, by the render server, the DRM content onto a protected Surface when the DRM content is displayed by a target XR application;
reading, by the render server, render data of the DRM content from the protected Surface through a protected first context, performing fusion rendering on the render data of the DRM content and a current scene in a same space to obtain first render data and storing the first render data into a protected first buffer; and
reading, by the compositor, the first render data from the protected first buffer through a protected second context, performing a compositing process on the first render data to obtain a first to-be-displayed image and displaying the first to-be-displayed image on screen.

2. The method according to claim 1, wherein the performing, by the render server, fusion rendering on render data of the DRM content and the current scene in a same space through the protected first context comprises:
detecting a playback status of the DRM content; and
performing, by the render server, fusion rendering on the render data of the DRM content and the current scene in the same space through the protected first context when the playback status of the DRM content is normal playback.

3. The method according to claim 2, further comprising:
performing, by the render server, fusion rendering on the render data of the DRM content and the current scene in the same space to obtain second render data through a non-protected first context and storing the second render data into a non-protected second buffer when the playback status of the DRM content is abnormal playback; and
reading, by the compositor, the second render data from the second buffer through a non-protected second context, performing a compositing process on the second render data to obtain a second to-be-displayed image and displaying the second to-be-displayed image on screen.

4. The method according to claim 1, wherein the protected Surface comprises a protected graphics buffer for storing render data of the DRM content;
the reading, by the render server, render data of the DRM content from the protected Surface through a protected first context, performing fusion rendering on the render data of the DRM content and a current scene in a same space to obtain first render data and storing the first render data into a protected first buffer comprises:
generating, by the render server, a drawing command, storing the drawing command to a protected command buffer and placing the drawing command from the protected command buffer into a protected command queue, and reading, by a protected submit module, the drawing command from the protected command queue and submitting the drawing command to a graphics processing unit (GPU) for execution; and
reading, by executing the drawing command, render data of the DRM content from the protected graphics buffer, performing fusion rendering on the render data of the DRM content and the current scene in the same space to obtain the first render data, and storing the first render data into the protected first buffer.

5. The method according to claim 4, wherein, the reading, by the compositor, the first render data from the protected first buffer through a protected second context, performing a compositing process on the first render data to obtain a first to-be-displayed image comprises:
reading, by the compositor, the first render data from the protected first buffer through the protected second context, performing the compositing process on the first render data to obtain display data of the first to-be-displayed image and storing the display data of the first to-be-displayed image in a protected third buffer.

6. The method according to claim 3, wherein, the performing, by the render server, fusion rendering on the render data of the DRM content and the current scene in the same space to obtain second render data through a non-protected first context and storing the second render data into a non-protected second buffer when the playback status of the DRM content is abnormal playback comprises:
generating, by the render server, a drawing command, storing the drawing command to a non-protected command buffer and placing the drawing command from the non-protected command buffer into a non-protected command queue, and reading, by a non-protected submit module, the drawing command from the non-protected command queue and submitting the drawing command to a GPU for execution; and
reading, by executing the drawing command, render data of the DRM content from the protected graphics buffer, performing fusion rendering on read content and the current scene in the same space to obtain the second render data and storing the second render data into the non-protected second buffer, wherein the read content is not the render data of the DRM content.

7. The method according to claim 6, wherein, the reading, by the compositor, the second render data from the second buffer through a non-protected second context, performing a compositing process on the second render data to obtain a second to-be-displayed image comprises:
reading, by the compositor, the second render data from the non-protected second buffer through the non-protected second context, performing a compositing process on the second render data, obtaining display data of the second to-be-displayed image and storing the display data of the second to-be-displayed image into a non-protected fourth buffer.

8. The method according to claim 3, wherein the playback status of the DRM content being abnormal playback comprises: the DRM content being in a screen recording status or a screenshotting status.

9. The method according to claim 1, wherein content in the current scene comprises a three-dimensional (3D) desktop, or the current scene comprises the 3D desktop and a display panel of at least one other XR application.

10. The method according to claim 3, wherein the first to-be-displayed image comprises the current scene and the DRM content, and the DRM content is superimposed on the current scene; and
the second to-be-displayed image comprises the current scene and a playback panel of the DRM content, and the playback panel of the DRM content is superimposed on the current scene, wherein the DRM content is not played on the playback panel of the DRM content.

11. The method according to claim 10, wherein the playback panel of the DRM content is black.

12. An XR device for rendering DRM content, comprising:
a render server, configured to render the DRM content onto a protected Surface when the DRM content is displayed by a target XR application, read render data of the DRM content from the protected Surface through a protected first context, perform fusion rendering on the render data of the DRM content and a current scene in a same space to obtain first render data and store the first render data into a protected first buffer; and
a compositor, configured to read the first render data from the protected first buffer through a protected second context, perform a compositing process on the first render data to obtain a first to-be-displayed image and display the first to-be-displayed image on screen.

13. The XR device according to claim 12, wherein performing, by the render server, fusion rendering on render data of the DRM content and the current scene in a same space through the protected first context comprises:
detecting a playback status of the DRM content; and
performing, by the render server, fusion rendering on the render data of the DRM content and the current scene in the same space through the protected first context when the playback status of the DRM content is normal playback.

14. The XR device according to claim 13, wherein the render server is further configured to:
perform fusion rendering on the render data of the DRM content and the current scene in the same space to obtain second render data through a non-protected first context and store the second render data into a non-protected second buffer when the playback status of the DRM content is abnormal playback; and
the compositor is further configured to:
read the second render data from the second buffer through a non-protected second context, perform a compositing process on the second render data to obtain a second to-be-displayed image and display the second to-be-displayed image on screen.

15. The XR device according to claim 12, wherein the protected Surface comprises a protected graphics buffer for storing render data of the DRM content;
the reading, by the render server, render data of the DRM content from the protected Surface through a protected first context, performing fusion rendering on the render data of the DRM content and a current scene in a same space to obtain first render data and storing the first render data into a protected first buffer comprises:
generating, by the render server, a drawing command, storing the drawing command to a protected command buffer and placing the drawing command from the protected command buffer into a protected command queue, and reading, by a protected submit module, the drawing command from the protected command queue and submitting the drawing command to a graphics processing unit (GPU) for execution; and
reading, by executing the drawing command, render data of the DRM content from the protected graphics buffer, performing fusion rendering on the render data of the DRM content and the current scene in the same space to obtain the first render data, and storing the first render data into the protected first buffer.

16. The XR device according to claim 15, wherein, the reading, by the compositor, the first render data from the protected first buffer through a protected second context, performing a compositing process on the first render data to obtain a first to-be-displayed image comprises:
reading, by the compositor, the first render data from the protected first buffer through the protected second context, performing the compositing process on the first render data to obtain display data of the first to-be-displayed image and storing the display data of the first to-be-displayed image in a protected third buffer.

17. The XR device according to claim 14, wherein, the performing, by the render server, fusion rendering on the render data of the DRM content and the current scene in the same space to obtain second render data through a non-protected first context and storing the second render data into a non-protected second buffer when the playback status of the DRM content is abnormal playback comprises:
generating, by the render server, a drawing command, storing the drawing command to a non-protected command buffer and placing the drawing command from the non-protected command buffer into a non-protected command queue, and reading, by a non-protected submit module, the drawing command from the non-protected command queue and submitting the drawing command to a GPU for execution; and
reading, by executing the drawing command, render data of the DRM content from the protected graphics buffer, performing fusion rendering on read content and the current scene in the same space to obtain the second render data and storing the second render data into the non-protected second buffer, wherein the read content is not the render data of the DRM content.

18. The XR device according to claim 17, wherein, the reading, by the compositor, the second render data from the second buffer through a non-protected second context, performing a compositing process on the second render data to obtain a second to-be-displayed image comprises:
reading, by the compositor, the second render data from the non-protected second buffer through the non-protected second context, performing a compositing process on the second render data, obtaining display data of the second to-be-displayed image and storing the display data of the second to-be-displayed image into a non-protected fourth buffer.

19. An XR device, comprising:
a processor and a non-transitory memory, wherein the non-transitory memory is configured to store a computer program, the computer program, upon execution by the processor, cause the processor to perform the method according to claim 1.

20. A non-transitory computer-readable storage medium storing instructions that cause a processor to:
render digital rights management (DRM) content onto a protected Surface when the DRM content is displayed by a target XR application;
read render data of the DRM content from the protected Surface through a protected first context, perform fusion rendering on the render data of the DRM content and a current scene in a same space to obtain first render data and store the first render data into a protected first buffer, and
read the first render data from the protected first buffer through a protected second context, perform a compositing process on the first render data to obtain a first to-be-displayed image and display the first to-be-displayed image on screen.
